(19) United States
(12) Patent Application Publication
(10) Pub. No.: US 2007/0234076 A1
(43) Pub. Date: Oct. 4, 2007

(54) POWER MANAGEMENT SYSTEM AND METHOD FOR NETWORK DEVICE

(75) Inventor: SHUN-CHENG YANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,585

(22) Filed: Aug. 26, 2006

(30) Foreign Application Priority Data
Mar. 31, 2006 (TW) 095111408

(51) Int. Cl. G06F 1/00

(52) U.S. Cl. 713/300

(57) ABSTRACT

A power management system for a network device is provided. The network device is connected to a user device and includes a system module. The power management system includes a main power module, a detecting module, and a power-driving module. The main power module is for supplying power to the system module. The detecting module is for detecting a connection status between the network device and the user device, and reading the connection status. The power-driving module is for detecting a status of the main power module, and sending a control signal according to the status of the main power module and the connection status detected by the detecting module.

### 1. FIELD OF THE INVENTION

The invention generally relates to a power management system and a method, and particularly to a power management system and a method for a network device.

### 2. DESCRIPTION OF RELATED ART

With advances in Internet technology, more and more enterprises are accessing the Internet via different network devices including modems, switches, hubs and so on. In a typical office environment, the network devices operate continuously. However, since office workers only get online via the network devices during business hours, continuous operation of the network devices after work hours leads to a waste of power.

A popular power saving mechanism features an integrated circuit capable of supporting a power saving function. However, the integrated circuit having the power saving function is expensive, and thus overall cost of the network devices is increased.

### SUMMARY OF THE INVENTION

A power management system for a network device is provided. The network device is connected to a user device and includes a system module. The power management system includes a main power module, a detecting module, and a power-driving module. The main power module is for supplying power to the system module. The detecting module is for detecting a connection status between the network device and the user device, and reading the connection status. The power-driving module is for detecting a status of the main power module, and sending a control signal according to the status of the main power module and the connection status detected by the detecting module.

A power management method for a network device is also provided. The network device is connected to a user device. The power management method includes detecting a connection status between the network device and the user device, and detecting whether a main power module is turned on if the network device and the user device are not connected, and sending an OFF signal to the main power supply if the main power supply is turned on.

Other advantages and novel features will become more apparent from the following detailed description when taken in conjunction with the accompanying drawings, in which:

### BRIEF DESCRIPTION OF THE DRAWINGS

FIG. 1 is schematic diagram illustrating an application environment of a power management system of an exemplary embodiment of the invention;

FIG. 2 is a block diagram of the power management system of another exemplary embodiment of the invention; and

FIG. 3 is a flow chart of a power management method of a further embodiment of the invention.

### DETAILED DESCRIPTION OF THE INVENTION

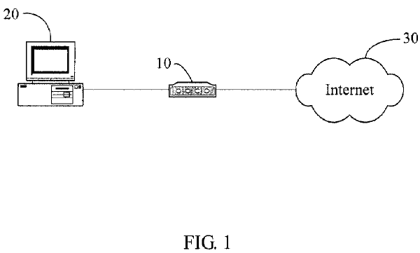

Referring to FIG. 1, a schematic diagram illustrating an application environment of a power management system 100 of an exemplary embodiment of the invention is shown. A user device 20 is connected to a network device 10 for accessing the Internet 30. In this embodiment, the network device 10 comprises a modem, and the user device 20 comprises a personal computer (PC).

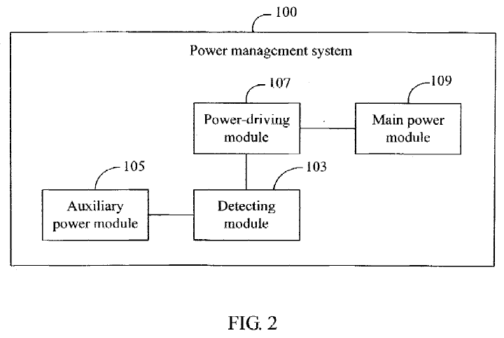

Referring to FIG. 2, a block diagram of the power management system 100 of another exemplary embodiment of the invention is shown. The power management system 100 includes a detecting module 103, an auxiliary power module 105, a power-driving module 107, and a main power module 109.

The detecting module 103 detects a connection status between the network device 10 and the user device 20, and then reads the connection status. In this embodiment, the detecting module 103 comprises an Ethernet chip, and the connection status includes an ON status and an OFF status.

The auxiliary power module 105 of this embodiment continuously supplies power to the detecting module 103.

The power-driving module 107 detects a status of the main power module 109, and sends a control signal according to the status of the main power module 109 and the connection status detected by the detecting module 103. In this embodiment, the control signal includes an OFF signal and an ON signal. The OFF signal and the ON signal are respectively for turning off and turning on the main power module 109. In detail, when the detecting module 103 detects that the network device 10 and the user device 20 are not connected and if the main power module 109 is already turned on, the power-driving module 107 sends the OFF signal to the main power module 109 to turn off the main power module 109, or otherwise the detecting module 103 continues detecting the connection status between the network device 10 and the user device 20. When the detecting module 103 detects that the network device 10 and the user device 20 are connected and if the main power module 109 is already turned off, the power-driving module 107 sends the ON signal to the main power module 109 to turn on the main power module 109, or otherwise the detecting module 103 continues detecting the connection status between the network device 10 and the user device 20. In this embodiment, the ON signal and the OFF signal are respectively a high-level trigger signal and a low-level trigger signal.

The main power module 109 supplies power to a system module (not shown) in the network device 10. In this embodiment, the main power module 109 is a direct current (DC)/DC converter. The system module is a central processing unit (CPU) for processing upper network protocols and performing packet format conversion.

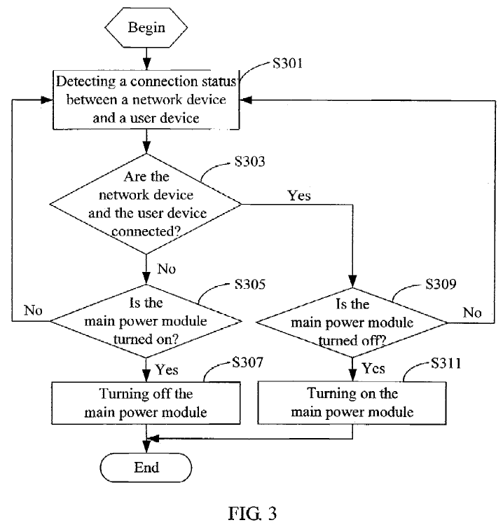

FIG. 3 is a flowchart of a power management method of a further embodiment of the invention.

In step S301, the detecting module 103 detects the connection status between the network device 10 and the user device 20.

In step S303, the detecting module 103 reads the connection status. If the network device 10 and the user device 20 are not connected, the process proceeds to step S305 described below. If the network device 10 and the user device 20 are connected, the process proceeds to step S309 described below.

In step S305, when the network device 10 and the user device 20 are not connected, the power driving module 107 detects whether the main power module 109 is turned on. If the main power module 109 is turned off, the process returns to step S301. If the main power module 109 is turned on, the process proceeds to step S307.

In step S307, when the main power module 109 is turned on, the power-driving module 107 send an OFF signal to the main power module 109 to turn off the main power module 109.

In step S309, when the network device 10 and the user device 20 are connected, the power-driving module 107 detects whether the main power module 109 is turned off. If the main power module 109 is turned on, the process returns to step S301. If the main power module 109 is turned off, the process proceeds to step S311.

In step S311, when the main power module 109 is turned on, the power-driving module 107 sends an ON signal to the main power module 109, in order to turn on the main power module 109.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A power management system for a network device, the network device connected to a user device and including a system module, the power management system comprising:
a main power module for supplying power to the system module;
a detecting module for detecting a connection status between the network device and the user device, and reading the connection status; and
a power-driving module for detecting a status of the main power module, and sending a control signal according to the status of the main power module and the connection status detected by the detecting module.

2. The power management system of claim 1, further comprising an auxiliary power module for supplying power to the detecting module.

3. The power management system of claim 1, wherein the network device comprises a modem.

4. The power management system of claim 1, wherein the detecting module comprises an Ethernet chip.

5. The power management system of claim 1, wherein the status of the main power module comprises an ON status and an OFF status.

6. The power management system of claim 1, wherein the control signal comprises an ON signal for turning on the main power module.

7. The power management system of claim 6, wherein the control signal further comprises an OFF signal for turning off the main power module.

8. The power management system of claim 7, wherein the OFF signal is a low-level trigger signal.

9. The power management system of claim 6, wherein the ON signal is a high-level trigger signal.

10. A power management method for a network device, the network device connected to a user device, the power management method comprising:
detecting a connection status between the network device and the user device;
reading the connection status;
detecting whether a main power module is turned on if the network device and the user device are not connected; and
sending an OFF signal to the main power supply if the main power supply is turned on.

11. The power management method of claim 10, further comprising detecting the connection status between the network device and the user device if the main power module is turned off.

12. The power management method of claim 10, further comprising detecting whether the main power module is turned off if the network device and the user device are not connected.

13. The power management method of claim 12, further comprising sending an ON signal to the main power module if the main power module is turned off.

14. The power management method of claim 13, further comprising detecting the connection status between the network device and the user device if the main power module is turned on.

15. A method for managing power of a network device, comprising the steps of:
establishing data-communicable connection between a user device and a network device for access to the internet;
detecting a connection status between said network device and said user device; and
turning off a main power of said network device for less power consumption of said network device when said network device and said user device are not in connection with each other based on said detected connection status.
